(19) United States
(12) Patent Application Publication
(10) Pub. No.: US 2015/0360996 A1
(43) Pub. Date: Dec. 17, 2015

(54) TEMPERATURE-RESISTANT ALUMINOSILICATE GLASS FIBERS AND METHOD FOR THE PRODUCTION THEREOF AND USE THEREOF

(71) Applicant: Heinz-Jürgen PREISS-DAIMLER, Wilsdruff (DE)

(72) Inventor: Heinz-Juergen PREISS-DAIMLER, Wilsdruff (DE)

(21) Appl. No.: 14/765,469

(22) PCT Filed: Feb. 18, 2014
(86) PCT No.: PCT/EP14/53031

§ 371 Date: Aug. 3, 2015

(30) Foreign Application Priority Data
Feb. 18, 2013 (JP) 10 2013 202 565.3
Feb. 17, 2014 (JP) 10 2014 202 850.7

(51) Int. Cl. C03C 13/00; C03B 37/02; D03D 15/00; C03C 25/42

(52) U.S. Cl. CPC C03C 13/00; C03C 25/42; C03B 37/02; D03D 15/0011; D10B 2401/063

(57) ABSTRACT

The present invention relates to temperature-resistant aluminosilicate glass fibers having the following composition: 52-60% by weight SiO2, 12-16% by weight Al2O3, <0.4% by weight Fe2O3, 0.03-0.3% by weight Na2O, 0.3-0.7% by weight K2O, 18-24% by weight CaO, 0.4-0.8% by weight MgO, 1-5% by weight TiO2, 0.5-3% by weight BaO, 0-2% by weight SrO, 0-3% by weight ZrO2, 0-1% by weight CuO, the total proportion of the alkaline earth metal oxides together being a maximum of 1.0% by weight, the total proportion of the oxides SrO, CuO, ZrO2 being in a range of 0.1 to 4.0% by weight and the temperature-resistant aluminosilicate glass fibers having a transformation temperature of >760° C. and a fiber formation temperature of <1260° C., preferably ≦1230° C.

The invention concerns temperature-resistant alumosilicate glass fibers and method for the production thereof and use thereof.

There are many inorganic fibers in the high temperature segment. Examples include silica fibers, glass fibers, ceramic fibers, biosoluble fibers, polycrystalline fibers and quartz fibers. Temperature-resistant fibers find use wherever high temperatures need to be controlled. Furthermore, fire protection in buildings is one area of application. Besides use in large industrial foundry facilities for metallic ores, steel and aluminum production, and industrial furnaces, one also finds temperature-resistant glass fibers increasingly in areas such as household appliances, the automotive industry, as well as the aerospace industry.

In modern high tech applications, besides the function of thermal insulation and/or isolation, fibers are also increasingly playing an important role in the reinforcement of plastics and concrete. The reinforcement fibers used here must have high tensile strength, along with their functionalized surface for better binding to their surrounding medium.

Many fiber materials are further processed by textile methods such as those for yarn, twine, weaves and other fabrics. Here as well, the mechanical parameters are of great importance, since these products are used primarily for reinforcement.

Temperature-resistant mineral fibers consist predominantly of the oxides SiO₂, Al₂O₃ and CaO with weight fractions of SiO₂ over 40 wt. %. Depending on their area of application, they can be specifically modified in their chemical composition by the addition of alkaline and alkaline earth oxides (such as Li₂O, Na₂O, K₂O, MgO, CaO) and transitional metal oxides (such as TiO₂, ZrO₂ and Y₂O₃). One distinguishes roughly between aluminum silicate fibers or RCF (refractory ceramic fiber), high-temperature glass fibers, AES (biosoluble fibers), polycrystalline fibers made through sol-gel processes, and silicate fibers.

For the production of glass fibers, one uses glass raw materials, recycled glass, volcanic stone or lime, with the designations indicating the raw material base. The melts of glass and stone mixtures are processed via fiber formation equipment into fibers with a diameter of 5 to 30 μm, with basically four different methods for the production of glass fibers. The filaments are bundled into a hundred or more and drawn onto a drum as so-called spin threads.

In the nozzle drawing process, the homogeneously melted glass mass flows continuously through hundreds of nozzle holes of a platinum nozzle vat. By utilizing gravity and drawing force, glass fibers are produced with a diameter of 5 to 30 μm. Thanks to gravitation, the quantity of replenishing glass melt remains constant, and by varying the rate of drawing the diameter of the glass filament can be controlled. The emerging filaments are cooled down under the action of convective cooling or water cooling and wound onto a drum. Before the winding process, the filaments are coated.

In the rod drawing process, several glass rods with a diameter of 2 to 8 mm are clamped together and the lower end is heated by a torch flame until it softens. The viscous glass melted at the lower end of the glass rod is drawn into a glass thread by gravity force and drawing force. Glass fiber fleece and textile glass yarns are made preferably by the rod drawing process.

In the centrifugal process, the glass melt is broken up into mineral fibers by means of centrifugal force under the action of an air current, which are collected as raw felt in collection chambers or gravity shafts.

With the nozzle blowing method, very fine and short glass fibers can be obtained. The glass melt here is pushed at high pressure and speed of up to 100 m/s through nozzles at the bottom of the melt vat. The fibers are broken up into short pieces here.

The naturally brittle glass when drawn out into a thin thread has a high flexibility and tensile strength at room temperature. Unlike aramide fibers or carbon fibers, the glass fibers are characterized by an amorphous structure. As with compact window glass, the molecular orientation is chaotic. A glass can therefore be viewed as a congealed liquid. After passing a certain temperature, known as the glass temperature or transformation temperature (T_{g}), a decoupling of the networks occurs, such that every glass undergoes a change in its shape stability. In this process, entirely or partially amorphous regions change into a rubber-elastic and highly viscous state. Above the transformation temperature, the strength and rigidity of amorphous glass fibers drop significantly.

The person skilled in the art understands by the term “transformation temperature” (T_{g}), by definition, the temperature used to characterize the position of the transformation region of a glass. The transformation temperature is a boundary between the brittle-elastic behavior of a solidified glass and the viscoplastic behavior of softened glass. The transformation temperature on average lies at a viscosity of 10^{13.3} dPa·s and can be determined per DIN ISO 7884-8:1998-02. The transformation region thus forms the transition from the elastic-brittle behavior to the highly viscous fluid behavior of the glass. The change in length of a glass is greater above the so-called transformation region, whose mean value is characterized by the transformation point T_{g}, than below it.

As a result, glass types can only withstand mechanical stresses below the transformation temperature, since they are highly viscous and fluid above the transformation temperature. For products which must have an elevated temperature resistance, there is thus an enormous demand for glass fibers characterized by a high transformation temperature.

WO 96/39362 and DE 2 320 720 A1 describe glass mixtures free of boric acid and fluorine for the production of glass fibers, so that the environmental burdens are minimized as compared to the production of glass fibers based on E glass. In order to still achieve the properties, the melting and the processing conditions of E glass types, a high fraction of MgO is added to the glass mixture as a substitute for the oxides CaO or TiO₂ of at least 2.0 wt. %. Yet due to the high fraction of MgO, such glass compositions have a strong tendency to form mixed crystals, so that the resulting glass types have a coarse crystalline structure. The poor chemical and thermal resistance as well as the tendency to stress cracks are a drawback with these glass types.

U.S. Pat. No. 3,847,627 A discloses a glass composition with a large CaO content in the range of 17 to 24 wt. % and a MgO content in the range of 1.5 to 4.0 wt. %, whose fiber formation temperature lies at least at a temperature of 1228° C. No values for the transformation temperature are to be found in this document.

From EP 2 321 231 A1 there are known high temperature and chemically resistant glass fibers based on a low fraction of Fe₂O₃, but an alternative addition of Cr₂O₃, having a good light transmission/refraction index. The temperature resistance of the described glass composition is at around 760° C. The temperature resistance is not satisfactory for a number of applications. A further drawback is the fiber formation temperature needed for the production of glass fibers, being over 1270° C.

At present, two types of glass fibers are known commercially whose temperature resistance is already substantially above the transformation temperature of 760° C.

First of all are the so-called S-glass fibers or HM-glass fibers, which are characterized by a high strength and a high E modulus and therefore can be used for the reinforcement of structural parts subject to rather high requirements for their strength and especially their rigidity. As a drawback, for some glass types very pure and costly oxides are used instead of the usual glass raw materials, and at the same time the high melting temperatures of this oxide mixture at around 1700° C. causes increased corrosion of the glass melting vats and their component parts. A heightened corrosion on the one hand shortens the service life of the glass melting vat and on the other hand causes worse glass quality, so that special melting methods are required.

In order to achieve economically attractive lifetimes of the component parts of melting vats, the melt temperature of a glass composition should be below 1400° C. However, the glass compositions presently known have the drawback that, when the melt temperature is lowered, the characteristic transformation temperature for the temperature resistance of a glass is also lowered.

On the other hand, chemically after-treated temperature-resistant glass fibers are known that are made from both E glass and also from special glass fibers. The special glass fibers prior to the chemical treatment consist primarily of SiO₂ and Na₂O. In additional steps, certain oxides (Na₂O) are entirely or partly extracted from the glass fibers over a lengthy time in hot acid, after which they are neutralized, chemically after-treated and finished. Such after-treated glass fibers can be stressed up to a temperature of 1000° C. Such glass types are costly to produce, due to the complex manufacturing process.

Thus, there continues to exist an elevated demand for temperature-resistant alumosilicate glass fibers with improved properties. In particular, there is a need to provide temperature-resistant alumosilicate glass fibers which fill the gap in terms of their temperature resistance between the conventional C, E and ECR glass types and the costly chemically after-treated glass types on the one hand, and which can be stressed up to a temperature of 1000° C., on the other hand.

Therefore, the problem which the invention proposes to solve is to provide a temperature-resistant alumosilicate glass fiber which is characterized by a transformation temperature of >760° C., while the melt temperature (Tₛ) and the fiber formation temperature (T_{f}) as well as the liquid temperature (TO are as low as possible. For emission protection reasons, the use of boron and fluorine compounds is to be avoided.

According to the invention, the problem is solved by a temperature-resistant alumosilicate glass fiber with the following composition:

| | | |
|---|---|---|
| 45-61 | wt. % | SiO₂ |
| 12-25 | wt. % | Al₂O₃ |
| 0.15-0.6 | wt. % | Fe₂O₃ |
| 0.03-0.6 | wt. % | Na₂O |
| 0.3-1.2 | wt. % | K₂O |
| 16-30 | wt. % | CaO |
| 0.4-0.8 | wt. % | MgO |
| 1-10 | wt. % | TiO₂ |
| 0.5-5 | wt. % | BaO |
| 0-10 | wt. % | SrO |
| 0-8 | wt. % | CuO |
| 0-5 | wt. % | ZrO₂, |

wherein at least one of the oxides SrO, CuO, ZrO₂ is present. In regard to the particular oxide, a fraction of 0 wt. % means that the oxide may be present with a fraction below the limit of detection. Impurities related to the raw materials or the process technology are excluded from this.

The temperature-resistant alumosilicate glass fiber consists of a composition free of boric acid, which is melted without the addition of raw materials containing boroxide.

Surprisingly, it has been found that the amorphous SiO₂ network of the alumosilicate glass fibers can be influenced specifically by doping with strontium and/or copper and/or zirconium atoms, which results in a change in the physical parameters of the material, especially the transformation temperature (T_{g}), melt temperature (Tₛ) and fiber formation temperature (T_{f}). The mentioned weight fractions of these oxides have proven to be especially suitable for enhancing mechanical characteristics (such as tensile strength, modulus of elasticity, elasticity, elongation, breaking strength, flexibility, etc.) of the glass fibers of the invention as compared to the glass fibers known from the prior art (E glass, ECR glass and C glass).

Upon cooling of the melt, the doping of the amorphous SiO₂ network with foreign ions demonstrably hinders the transition from the metastable amorphous modification to the energy-favored crystalline modification. Surprisingly, dopings with network transformers such as strontium and/or copper and/or barium atoms have proven to be especially advantageous for this.

By a doping of the SiO₂ network of known glass compositions with the mentioned network transformers, T_{g} can be increased to over 760° C., while at the same time Tₛ and T_{f} can be lowered or kept constant. Thanks to the chosen composition, such a glass melt is suitable for the production of continuous glass fibers at low temperature.

The addition of ZrO₂ increases the transformation temperature higher than Al₂O₃, but at the same time it raises the melt temperature.

Surprisingly, it has been found that the transformation temperature is hardly influenced by the oxides CaO, SrO and BaO, while the oxides SiO₂, Al₂O₃, MgO, ZrO₂ and TiO₂ increase the transformation temperature. On the other hand, the oxides Na₂O, K₂O and CuO even in small amounts very substantially lower the transformation temperature.

Furthermore, it was found that the oxides SiO₂, Al₂O₃ and ZrO₂ raise the melt temperature Tₛ and the fiber formation temperature T_{f}. By contrast, the oxide Fe₂O₃, which gets into the glass without influence via the raw materials, lowers both the transformation temperature as well as the melt temperature Tₛ and fiber formation temperature T_{f}.

The addition of TiO₂ raises the transformation temperature and lowers the fiber formation temperature and melt temperature.

On the other hand, an added fraction of CuO contributes to a lowering of Tₛ and T_{f}.

ZrO₂ at the expense of SiO₂ raises T_{g}, as well as the melt and fiber formation temperature.

The glass fibers of the invention can be present both in the form of filaments and in the form of staple fibers.

The fiber diameter of the glass fibers of the invention is preferably 5-30 μm, especially preferably 5-25 μm.

According to one embodiment of the invention, the alumosilicate glass fibers preferably contain 1-8 wt. % of SrO, especially 2-6 wt. % of SrO and/or preferably 0.5-6 wt. % of CuO, especially 0-1.0 wt. % of CuO, and/or preferably 3 wt. % of ZrO₂, especially 0-2.0 wt. % of SrO.

In one preferred embodiment of the invention, the composition of the alumosilicate glass fibers of the invention has the following fractions (in terms of the overall composition) of oxides:

| | | |
|---|---|---|
| 52-60 | wt. % | SiO₂ |
| 12-16 | wt. % | Al₂O₃ |
| <0.4 | wt. % | Fe₂O₃ |
| 0.03-0.3 | wt. % | Na₂O |
| 0.3-0.7 | wt. % | K₂O |
| 18-24 | wt. % | CaO |
| 0.4-0.8 | wt. % | MgO |
| 1-5 | wt. % | TiO₂ |
| 0.5-3 | wt. % | BaO |
| 0-2 | wt. % | SrO |
| 0-3 | wt. % | ZrO₂, |
| 0-1 | wt. % | CuO |

wherein the total fraction of the alkaline earth metal oxides (Na₂O and K₂O) is at most 1.0 wt. % in total,

wherein the total fraction of the oxides SrO, CuO, ZrO₂ lies in a range of 0.1 to 4.0 wt. %, and

wherein the temperature-resistant alumosilicate glass fiber has a transformation temperature >760° C. and a fiber formation temperature (viscosity of 10^{3.0} dPa·s) <1260° C., preferably ≦1230° C.

The alumosilicate glass fiber according to the invention has the following properties after its production:
a) a transformation temperature >760° C.,
b) a fiber formation temperature <1260° C., preferably ≦1230° C.,
c) a melt temperature <1400° C.

Surprisingly, it has been found that the initial tear strength of the glass fibers according to the invention and the fabric made from them after their production is around 15% above the initial tear strength of the E glass types and ECR glass types known in the prior art.

Especially advantageous is the remaining residual strength (relative residual tear strength) of the glass fibers of the invention with a diameter in the range of 9 to 15 μm and the fabric made from them after a temperature stress of 760° C. in the range of 10% to 15% compared to the initial tear strength at room temperature.

Strength is a material property which describes the mechanical resistance which a material presents to a plastic deformation. According to the invention, strength refers to the tensile strength. The tensile strength is the highest resistance of the glass fiber to a tensile stress without breaking. The tensile strength and elongation at maximum force are measured in a pull test, which is familiar to the skilled person.

By definition, the residual tear strength is the remaining tear strength of a glass fiber or a fabric made therefrom after a thermal or chemical stress. The remaining residual tear strength (relative residual tear strength) after the thermal or chemical stressing of a glass fiber of a fabric made therefrom can be indicated as a percentage with regard to the initial tear strength of the glass fiber or the fabric.

The residual tear strength of a glass fiber or a fabric made therefrom is determined before and after a temperature stress by clamping it in a suitable tear testing machine and under the action of a constant rate of feed until the glass fiber or fabric is torn.

For the temperature treatment, test fabric strips (5×30 cm) are exposed to a constant temperature for 1 h in a thermal cabinet. After cooling, the tear strength is determined by measuring the force in Newtons and the change in length in millimeters of this test fabric.

The initial strength of the test fabric without thermal stress and the tear strength of the heat-treated test fabric are determined. The relative residual tear strength is found from the percentage ratio of the tear strength of the heat-treated test fabric to the initial strength of the non-heat-treated test fabric.

Surprisingly, moreover, it has been found that the alumosilicate glass fibers with the composition of the invention, containing the oxides SrO, ZrO₂, and/or CuO, have a good resistance to alkali.

Methods for determining the alkali resistance of glass fibers are quite familiar to the skilled person and can be found in corresponding guidelines, such as ETAG 004 (External Thermal Insulation Composite Systems with Rendering—Edition 08/2011—long-term determination) or DIN EN 13496:1999-06 (short-term determination).

Fabrics of alumosilicate glass fibers of the composition according to the invention advantageously have a residual tear strength of at least 70% after a short-term alkali treatment (per DIN EN 13496:1999-06) and at least 65% after a long-term alkali treatment (per ETAG 004).

It has been found that Na₂O and K₂O are water soluble oxides, which contribute to an unwanted lowering of the transformation temperature T_{g}. In the preferred embodiment of the invention, the glass composition according to the invention has the alkaline earth oxides Na₂O and K₂O together with a maximum combined fraction of 1.0 wt. %. Preferably, the glass composition of the invention has the alkaline earth oxide Na₂O with a maximum fraction of 0.25 wt. %.

However, as a complicating factor, it has been found that most oxides react with each other and thus the effects of individual oxides in the glass composition of the invention are very greatly dependent on their fraction. An especially preferred glass composition of the alumosilicate glass fibers of the invention is therefore characterized in that the fraction of SiO₂ (in terms of the overall composition) lies in a range of 54.0 to 58.0 wt. %.

An especially preferred glass composition of the alumosilicate glass fiber of the invention has a fraction of Al₂O₃ in the range of 14.0 and 16.0 wt. % and a fraction of CaO in the range of 20.0 to 22.0 wt. %.

In the same context, the glass composition according to the invention has the required oxides MgO and Fe₂O₃, preferably with a fraction of MgO in the range of 0.5 to 0.8 wt. % and of Fe₂O₃ at a maximum of 0.3 wt. %.

In an especially advantageous embodiment of the invention, the glass composition of the invention has the oxides TiO₂ and BaO combined with a total fraction in the range of 4.0 to 6.0 wt. %.

Glass fibers according to the invention with an especially preferred glass composition have a transformation temperature of at least 765° C., most especially advantageously of at least 770° C. Thanks to the high transformation temperature, the glass fibers of the invention can especially advantageously withstand higher stresses.

At the same time, the glass compositions according to the invention can be economically melted and formed into glass fibers.

A temperature stressing of glass essentially results in formation of defects in the SiO₂ network. This structural damage to the SiO₂ network remains intact after the cooling to room temperature.

Thanks to the composition of the oxides according to the invention, the glass filaments obtained from the melt after a temperature stressing of 760° C. are characterized by a remaining tear strength which is equal to or higher than the tear strength of E glass, ECR glass and C glass after the same temperature stress.

The temperature-resistant alumosilicate glass fibers according to the invention after a temperature stress of 760° C. have less structural damage to the SiO₂ network than the glass fibers known from the prior art (E glass, ECR glass and C glass). The alumosilicate glass fibers according to the invention are therefore characterized after a temperature stress of 760° C. by a remaining tear strength of at least 10% with respect to the initial strength (initial tear strength) at room temperature without temperature stress.

The glass fibers of the invention can be present both in the form of filaments and in the form of staple fibers.

The invention also concerns a method for the production of a temperature-resistant alumosilicate glass fiber which has the following steps:
a. Preparation of a glass melt, having the following fractions of oxides:

| | | |
|---|---|---|
| 45-61 | wt. % | SiO₂ |
| 12-25 | wt. % | Al₂O₃ |
| 0.15-0.6 | wt. % | Fe₂O₃ |
| 0.03-0.6 | wt. % | Na₂O |
| 0.3-1.2 | wt. % | K₂O |
| 16-30 | wt. % | CaO |
| 0.4-0.8 | wt. % | MgO |
| 1-10 | wt. % | TiO₂ |
| 0.5-5 | wt. % | BaO |
| 0-10 | wt. % | SrO |
| 0-8 | wt. % | CuO |
| 0-5 | wt. % | ZrO₂, |

wherein at least one of the oxides SrO, CuO, ZrO₂ is present.
b. Converting the melt into filaments or staple fibers,
c. Cooling the resulting filaments or staple fibers,
d. Coiling the filaments into spin threads or making textiles,
e. Drying of the resulting filaments or staple fibers or textiles.

The method according to the invention has the advantage that temperature-resistant glass fibers are produced wherein the residual strength of the threads and fabrics after a temperature stress of 760° C. is still 10% with respect to the initial strength at room temperature.

Now, it has also been shown to be advantageous that the residual tear strength of the glass fibers of the invention with a diameter in the range between 9 and 15 μm and of the fabric made from them after a temperature stress of 760° C. is in the range between 10% and 15% with respect to the initial tear strength at room temperature.

The invention has the further advantage that the melt temperature (Tₛ), the liquidus temperature (T₁) and the fiber formation temperature (T_{f}) are lowered for an economical production and a stable process in the fiber manufacturing.

Thus, the glass composition according to the invention has the following properties:
a) a transformation temperature >760° C.,
b) a fiber formation temperature <1260° C.,
c) a melt temperature <1400° C.

A method has been found to be an especially advantageous embodiment of the method of the invention for production of a temperature-resistant glass fiber in which
a. a glass melt is prepared, having the following fractions of oxides (in terms of the overall composition):

| | | |
|---|---|---|
| 52-60 | wt. % | SiO₂ |
| 12-16 | wt. % | Al₂O₃ |
| <0.4 | wt. % | Fe₂O₃ |
| 0.03-0.3 | wt. % | Na₂O |
| 0.3-0.7 | wt. % | K₂O |
| 18-24 | wt. % | CaO |
| 0.4-0.8 | wt. % | MgO |
| 1-5 | wt. % | TiO₂ |
| 0.5-3 | wt. % | BaO |
| 0-2 | wt. % | SrO |
| 0-3 | wt. % | ZrO₂, |
| 0-1 | wt. % | CuO |

wherein the total fraction of the alkaline earth metal oxides (Na₂O and K₂O) is at most 1.0 wt. % in total,

wherein the total fraction of the oxides SrO, CuO, ZrO₂ lies in a range of 0.1 to 4.0 wt. %, and

wherein the temperature-resistant alumosilicate glass fiber has a transformation temperature >760° C. and a fiber formation temperature <1260° C.,

wherein there next occurs:
b. a converting of the melt into filaments or staple fibers,
c. a cooling of the resulting filaments or staple fibers,
d. a coiling of the filaments into spin threads or making textiles and
e. a drying of the resulting filaments or staple fibers or textiles.

Surprisingly, it has been found that thanks to the fraction of SrO according to the invention the viscosity of the glass melt is lowered at high temperatures for Tₛ and T_{f}, and thus the flow behavior (rheology) of the glass melt is advantageously improved.

It has been found surprisingly that the fraction of TiO₂ according to the invention lowers the melt temperature of the glass composition. Moreover, TiO₂, SrO and CuO act advantageously as a flux at higher temperatures, which increases the viscosity of the glass composition in the low temperature region (transformation region T_{g}). Too high a fraction of TiO₂ appears to be disadvantageous, as it supports the unwanted crystallization.

In one especially preferred embodiment of the invention, the glass composition according to the invention has TiO₂ with a fraction of 1 to 5 wt. %, most preferably 2.5 to 3.5 wt. %.

Preferably, the glass melt according to the invention has the alkaline earth oxide Na₂O with a maximum fraction of 0.25 wt. %.

An especially preferred composition of the glass melt of the invention is therefore characterized in that the fraction of SiO₂ (in terms of the overall composition) lies in a range of 54.0 to 58.0 wt. %.

Especially preferably, the composition of the glass melt according to the invention has a fraction of Al₂O₃ in the range of 14.0 and 16.0 wt. % and a fraction of CaO in the range of 20.0 to 22.0 wt. %.

The glass melt according to the invention has the required oxides MgO and Fe₂O₃, preferably with a fraction of MgO in the range of 0.5 to 0.8 wt. % and of Fe₂O₃ at a maximum of 0.3 wt. %.

In an especially advantageous embodiment of the invention, the composition of the glass melt according to the invention has the oxides TiO₂ and BaO combined with a total fraction in the range of 4.0 to 6.0 wt. %.

Above the liquidus temperature (T₁) the glass is completely melted and there are no longer any crystals.

The fiber formation temperature (T_{f}) is the temperature of a glass melt at which the viscosity of the melt is 10³ dPa·s. A low T_{f} simplifies the drawing process for converting the melt into filaments. At this viscosity, the stress during the fiber production is the lowest, which increases the strength of the fiber. Furthermore, less energy is required and thus the production costs can be kept low.

According to the invention, an oxide blend is prepared which is heated in a melting vat by means of gas and/or electric melting until liquefied. After this, the homogeneous glass melt is converted into glass filaments or staple fibers.

After the complete melting of the mixture and the homogenization of the glass melt, the glass melt is purified before being converted into filaments. The purification serves to drive out and reduce the gas fractions from the glass melt. Additives for the purification are often prescribed and therefore are basically known to the skilled person. Thus, besides ammonium nitrate, one generally adds sodium nitrate or sodium sulfate for the purification of the glass melt.

Surprisingly it has now been found that the addition of BaO does not affect the transformation temperature, but can advantageously lower the temperatures Tₛ and T_{f}.

In one especially preferred embodiment of the method of the invention, when preparing the glass melt one adds instead of sodium sulfate or sodium nitrate a fraction of the total fraction of BaO as barium sulfate with a fraction of 0.4 wt. %. Advantageously, the adding of barium sulfate serves as a purification agent.

The converting of the melt into filaments occurs by the nozzle drawing method, wherein the filaments are cooled as they emerge from the nozzles. The dissipation of heat is preferably done by convective and/or water cooling.

Due to the high drawing speeds acting on the glass threads emerging from the nozzles during the converting of the glass melt into glass filaments, a glass structure is formed which is especially prone to near-surface defects (such as Griffith cracks).

According to one embodiment of the method of the invention, the glass filaments obtained from the glass melt are therefore treated with a size after the cooling process, which can repair or close up the near-surface defects. The elimination of near-surface defects hinders the propagation of open structures, which reduces the cracking tendency of the glass filaments. The strength of the material is also increased by the sizing of the glass filaments.

The main purpose of the sizing is to protect the glass fibers for the later process steps. Glass fibers according to the invention and their products (such as fabrics) which are not desized are already provided by the size with bonding agents for the respective applications.

More coarse textiles from direct rovings have a size which is compatible with the matrix. For this reason, these textiles are not desized.

Textiles of finer threads normally have a size of predominantly organic, partly fatty substances, which need to be removed. The removal of the size is done by heat treatment at temperatures over 400° C. After this desizing, another substance is deposited on the textile which is compatible with the particular matrix. The loss of strength is low in the case of textiles made from temperature-resistant alumosilicate glass fibers which are thermally desized and provided with a finish.

According to one embodiment of the method of the invention, the size preferably contains inorganic substances, such as silanes or substances from sol-gel methods. A silane size or sol-gel sizing can be carried out in the production process at glass fiber temperatures up to 100° C.

Glass threads which have been treated with a silane size are distinguished by a higher strength than glass threads which were treated with a size without silanes. Finally, the present invention concerns the use of temperature-resistant alumosilicate glass fibers as are described by the invention.

The temperature-resistant alumosilicate glass fibers according to one preferred embodiment of the invention find uses in the production of high-tensile glass fibers, twine, fleece, fabric or textiles, or fabric for catalysts, filters or other fiber products.

The temperature-resistant alumosilicate glass fibers can be texturized for the use of the temperature-resistant alumosilicate glass fibers of the invention as fabrics for catalysts, for example.

Preferably, moreover, the temperature-resistant alumosilicate glass fibers of the invention find use in the production of textiles, where the textiles consist of temperature-resistant alumosilicate glass fibers that are thermally desized after the weaving and treated with a finish, and have a low strength loss.

### Sample Embodiment 1

With the aid of the following sample embodiments, the invention will be explained more closely:

In order to illustrate the influences of the fractions of the oxides SrO, CuO, ZrO₂ according to the invention on the transformation temperature and the melt temperature, the six following glass melts were produced, having identical fractions of Fe₂O₃, Na₂O, K₂O, CaO, MgO, TiO₂ and BaO in their composition.

The following table 1 shows a summary of the currently used chemical compositions of alumosilicate glass fibers (reference glass types) as compared to the chemical composition of the temperature-resistant alumosilicate glass fibers according to the invention (glass No. 1-6). All information is in wt. %.

TABLE 1
influence of the oxides on the temperature parameters of glass types

| | Sample embodiments, glass No.: | | | | | | Reference glass types | | |
|---|---|---|---|---|---|---|---|---|---|
| Components | 1 | 2 | 3 | 4 | 5 | 6 | ECR | E glass | C glass |
| SiO₂ | 48.6 | 48.6 | 48.6 | 46.6 | 48.6 | 46.6 | 59.2 | 53.4 | 68.3 |
| Al₂O₃ | 15.6 | 15.6 | 13.6 | 15.6 | 13.6 | 15.6 | 14.1 | 14.8 | 2.8 |
| Fe₂O₃ | 0.3 | 0.3 | 0.3 | 0.3 | 0.3 | 0.3 | 0.3 | 0.2 | 0.1 |
| Na₂O | 0.0 | 0.0 | 0.0 | 0.0 | 0.0 | 0.0 | 0.1 | 0.2 | 13.7 |
| K2O | 0.6 | 0.6 | 0.6 | 0.6 | 0.6 | 0.6 | 0.6 | 0.2 | 3.0 |
| CaO | 19.9 | 19.9 | 19.9 | 19.9 | 19.9 | 19.9 | 22.8 | 22.4 | 5.4 |
| MgO | 0.6 | 0.6 | 0.6 | 0.6 | 0.6 | 0.6 | 0.3 | 0.1 | 5.0 |
| TiO₂ | 7.9 | 7.9 | 7.9 | 7.9 | 7.9 | 7.9 | 2.6 | 0.2 | 0.2 |
| BaO | 0.5 | 0.5 | 0.5 | 0.5 | 0.5 | 0.5 | 0.0 | 0.0 | 0.0 |
| SrO | 6.0 | | 6.0 | 6.0 | | | 0.0 | 0.0 | 0.0 |
| CuO | | 6.0 | | | 6.0 | 6.0 | 0.0 | 0.0 | 0.0 |
| ZrO₂ | | | 2.0 | 2.0 | 2.0 | 2.0 | 0.0 | 0.0 | 0.0 |
| B₂O₃ | | | | | | | 0.0 | 8.5 | 1.5 |
| T_{g} | 775 | 767 | 783 | 785 | 775 | 778 | 753 | 675 | 527 |
| T_{f} | 1125 | 1169 | 1236 | 1232 | 1180 | 1112 | 1300 | 1198 | 1180 |
| Tₛ | 1358 | 1246 | 1375 | 1355 | 1261 | 1245 | 1459 | 1344 | 1426 |

The glass blends for the glass types per table 1 are heated until liquid in a melting vat. Using the force of gravity and pulling force, glass threads are created with a nozzle drawing method and wound onto a rotating spool. For cooldown, the glass fibers emerging from the nozzles are treated by means of convective and water cooling.

The transformation temperature is the boundary between the brittle-elastic behavior of solidified glass and the viscoplastic behavior of softened glass. On average, it lies at a viscosity of 10^{13.3} dPa·s and was determined per DIN ISO 7884-8:1998-02 at the intersection of the lines of tangency traced at the legs of the inflected curve of elongation.

It follows from table 1 that the fractions of the oxides have an influence on the temperature parameters (T_{g}, T_{f} and Tₛ) of the individual glass fibers. As compared to the reference glass types, all experimental glass types of the invention have a higher T_{g}, while T_{g} is greater than 760° C. At the same time, Tₛ and T_{f} of the experimental glass types of the invention are lowered on average by 100° C. and 50° C.

As regards the experimental glass types of the invention among themselves, a fraction of 6 wt. % of SrO leads to an increasing of Tₛ, T_{f} and T_{g}. On the other hand, an added fraction of 6 wt. % of CuO contributes to a lowering of Tₛ and T_{f}. A fraction of 2 wt. % of ZrO₂ at the expense of the fraction of Si0₂ leads to a raising of T_{g}, while the temperature parameters T_{f} and Tₛ are decreased by the fraction of CuO. TiO₂ acts like SrO, increasing T_{g} and decreasing T_{f} and Tₛ.

### Sample Embodiment 2

In order to illustrate the influences of the fractions of the oxides SrO, CuO, ZrO₂ according to the invention on the transformation temperature and the fiber formation temperature, the seven following glass melts were furthermore prepared. Table 2 gives the corresponding compositions for the glass types with numbers 8 to 13. As purifying agent, only barium sulfate was added to the glass melts with a fraction of 0.4 wt. % in terms of the total fraction of BaO.

Table 2 shows the chemical glass compositions of three commercially available alumosilicate glass fibers (reference glass types) as compared to the seven sample glass compositions of the temperature-resistant alumosilicate glass fibers according to the invention (glass No. 7-13). All information is in wt. %.

The adding of ZrO₂ (0.3 wt. % in glass No. 8) increases T_{g}, but at the same time also leads to a raising of T_{f}. Thanks to the addition of SrO (4.0 wt% in glass No. 10), Tₛ can be significantly lowered to 1363° C., while at the same time T_{g} rises slightly. If both oxides are used in combination (see glass No. 11 and 12), their effects on T_{g}, T_{f} and T₁ depend on the respective total fraction of the glass composition, while the adding of CuO (0.1 wt. % in glass No. 13) permits a fine tuning of the characteristic temperatures.

Moreover, glass No. 11 contains TiO₂ with a total concentration of 8.3 wt. %, which increases T_{g} and at the same time lowers the melt and fiber formation temperature.

TABLE 2
influence of the oxides on the temperature parameters of glass types

| | Sample embodiments, glass No.: | | | | | | | Reference glass types | | |
|---|---|---|---|---|---|---|---|---|---|---|
| Components | 7 | 8 | 9 | 10 | 11 | 12 | 13 | ECR | E glass | C glass |
| SiO₂ | 58.3 | 56.0 | 58.2 | 52.5 | 46.0 | 54.5 | 54.5 | 59.2 | 53.4 | 68.3 |
| Al₂O₃ | 13.5 | 15.2 | 15.4 | 15.5 | 12.0 | 14.8 | 14.8 | 14.1 | 14.8 | 2.8 |
| Fe₂O₃ | 0.3 | 0.3 | 0.3 | 0.3 | 0.3 | 0.3 | 0.3 | 0.3 | 0.2 | 0.1 |
| Na₂O | 0.0 | 0.2 | 0.2 | 0.0 | 0.0 | 0.2 | 0.2 | 0.1 | 0.2 | 13.7 |
| K₂O | 0.6 | 0.7 | 0.7 | 0.7 | 0.6 | 0.7 | 0.7 | 0.6 | 0.2 | 3.0 |
| CaO | 22.0 | 22.0 | 20.0 | 22.0 | 20.0 | 20.4 | 20.3 | 22.8 | 22.4 | 5.4 |
| MgO | 0.6 | 0.6 | 0.6 | 0.5 | 0.6 | 0.6 | 0.6 | 0.3 | 0.1 | 5.0 |
| TiO2 | 2.6 | 2.6 | 2.6 | 2.4 | 8.3 | 3.5 | 3.5 | 2.6 | 0.2 | 0.2 |
| BaO | 2.0 | 2.0 | 2.0 | 2.0 | 0.3 | 2.0 | 2.0 | 0 | 0 | 0 |
| SrO | | | | 4.0 | 8.0 | 1.0 | 1.0 | 0 | 0 | 0 |
| ZrO₂ | | 0.3 | | | 4.0 | 2.0 | 2.0 | 0 | 0 | 0 |
| CuO | | | | | | | 0.1 | 0 | 0 | 0 |
| B₂O₃ | | | | | | | | 0 | 8.5 | 1.5 |
| T_{g} [° C.] | 757 | 765 | 760 | 764 | 763 | 772 | 763 | 753 | 675 | 527 |
| T_{f} [° C.] | 1161 | 1186 | 1212 | 1151 | 1127 | 1230 | 1215 | 1285 | 1156 | 1011 |
| Tₛ [° C.] | 1449 | 1421 | 1482 | 1363 | 1350 | 1450 | 1448 | 1458 | 1345 | 1425 |

### Sample Embodiment 3—Determination of the Residual Tear Strength After Temperature Stress

To determine the initial tear strength, test fabrics in strip form (5×30 cm in the warp direction and 5×30 cm in the weft direction) are tested in a triple determination on a tear testing machine (Zwick GmbH & Co. KG) with a maximum tearing force of 10 kN with a distance of 10 cm between the clamps and a constant feed rate of 100 mm/min and the average of 3 test fabrics was calculated.

### Temperature Stress

For the determination of the temperature resistance, the test fabrics in strip form (5×30 cm; 9 μm glass threads) are treated in a thermal cabinet at 400° C. for 1 h. The test fabrics are then removed from the thermal cabinet and cooled down to around 20° C. at room temperature.

In keeping with the above, test fabrics are treated each time in strip form (5×30 cm; 9 μm glass threads) in a thermal cabinet at 500° C., 600° C., 650° C., 700° C., 750° C. or 800° C. for 1 h and then cooled down at room temperature to around 20° C.

The testing of the residual tear strength of the heat-treated and cooled down test fabrics is done similar to the determination of the initial tear strength.

The following table 3 shows the relative tear strength values for the individual temperatures, the initial tear strength being assumed to be 100% and the relative residual tear strengths being calculated [in %] as a percentage of the initial tear strength.

Test fabrics of E glass and ECR glass served as references.

TABLE 3
relative residual tear strength [in %] after temperature stress

| Glass | 400° C. | 600° C. | 650° C. | 700° C. | 750° C. | 800° C. |
|---|---|---|---|---|---|---|
| E glass | 13 | 8 | 6 | 1 | — | — |
| ECR | 19 | 10 | 10 | 9 | 5 | — |
| Glass No. 8 | 20 | 15 | 14 | 14 | 11 | 1 |

Table 3 shows that the relative residual tear strength of all three test fabrics decreases with increasing temperature stress (from 400 to 700° C.). While test fabrics of E glass after a temperature stress of 750° C. have no residual strength, test fabrics of ECR glass still have a relative residual tear strength of 5% as compared to the initial tear strength. Furthermore, test fabrics of glass fibers of the composition according to the invention after a temperature stress of 750° C. still have a relative residual tear strength of 11% and after a temperature stress of 800° C. a remaining relative residual tear strength of 1% as compared to the initial tear strength.

### Sample Embodiment 4—Alkali Resistance

By analogy with sample embodiment 3, the initial tear strengths of the glass fiber fabrics made from glass fibers of the invention of glass No. 8 (see table 2, sample embodiment 2) were determined at a constant feed rate of (50 ±5) mm/min. Each time, test fabrics of E glass or ECR glass fibers served as the references.

### Short-Term Alkali Treatment Per DIN EN 13496:1999-06

For the determination of the residual tear strength after a short-term alkali treatment per DIN EN 13496:1999-06, the test fabrics as strips (5 cm x 30 cm; 9 pm glass threads) are dipped into an alkaline solution (1 g NaOH, 4 g KOH, 0.5 g Ca(OH)₂ per one liter of distilled water) in the weft direction and kept there for 24 hours at a temperature of (60±2) ° C. The determination of the alkali resistance is done each time as a seven-fold determination per test fabric.

As reference, the respective test fabrics were kept under ambient conditions for at least 24 h at (23±2) ° C. and (50±5)% relative humidity.

After being kept in the alkaline solution, the test fabrics are rinsed with running tap water at a temperature of (20±5) ° C. until the pH value on the surface, measured with a pH indicator paper, is less than pH 9. After this, the test fabrics are kept in 0.5% hydrochloric acid for 1 h. After this, the test fabrics are rinsed in running tap water without much movement, until a pH value of 7 is achieved, measured by pH indicator paper. The test fabrics are dried for 60 min at (60±2) ° C. and then kept for at least 24 h at (23±2) ° C. and (50±5)% relative humidity before being tested.

To determine the residual tear strength (see table 4), the test fabrics are clamped in the tear testing machine and pulled at a constant feed rate of (50±5) mm/min until the test fabric is torn. During the testing, the force is determined in Newtons and the change in length in millimeters.

After the alkali treatment per DIN EN 13496:1999-06, a comparable relative residual tear strength of 75% and 76% was determined for all the test fabrics.

### Long-Term Alkali Treatment Per ETAG 004

The long-term alkali resistance of the test fabrics (fabrics) is determined by ETAG 004 (Edition 08/2011), section 5.6.7.1.2. For this, the test fabrics are dipped as strips (5 cm×5 cm; 9 pm glass threads) with the glass composition according to the invention per glass No. 8 (see table 2) into an alkaline solution (1 g NaOH, 4 g KOH, 0.5 g Ca(OH)₂ per one liter of distilled water) at (28±2) ° C. in the weft direction for 28 days.

After this, the test specimens are rinsed by five minutes of dipping into an acid solution (5 ml of 35% HCl diluted to 4 liters of water) and then placed in succession into 3 water baths (each one 4 liters). The test fabrics are left in each water bath for 5 minutes.

After this, the test fabrics are dried for 48 hours at (23 ±2) ° C. and (50 ±5)% relative humidity. The residual tear strengths found after the alkali treatment are given in table 4. For textile glass lattices, the residual tear strength must be at least 50% of the initial tear strength.

For test fabric made from the glass fibers of the invention per glass No. 8 (1618.6 N/5 cm), a comparable relative tear strength of 69% was determined as for test fabric of ECR glass (1488.4 N/5 cm or 70%). On the other hand, test fabrics of E glass only exhibited a relative residual tear strength of 64% as compared to the untreated test fabrics.

The higher initial tear strength of the glass fibers according to the invention as compared to glass fibers of E glass or ECR glass should be pointed out as especially advantageous, as is shown by the comparison of glass No. 8 to E glass and ECR glass.

TABLE 4
relative residual tear strength [in %] after alkali stress.

| | | Residual tear strength | |
|---|---|---|---|
| | Initial tear | after 24 h, 60° C. | Residual tear strength |
| | strength | DIN EN 13496, | after 28 d, ETAG 004, |
| Glass | [N/5 cm] | [N/5 cm]/[%] | [N/5 cm]/[%] |
| E glass | 1986.7 | 1484.4/75 | 1264.8/64 |
| ECR | 1952.5 | 1607.4/76 | 1488.4/70 |
| Glass No. 8 | 2345.5 | 1769.0/75 | 1618.6/69 |

1. A temperature-resistant alumosilicate glass fiber, comprising:

| | | |
|---|---|---|
| 52-60 | wt. % | SiO₂, |
| 14-16 | wt. % | Al₂O₃, |
| <0.4 | wt. % | Fe₂O₃, |
| 0.03-0.3 | wt. % | Na₂O, |
| 0.3-0.7 | wt. % | K₂O, |
| 20-22 | wt. % | CaO, |
| 0.4-0.8 | wt. % | MgO, |
| 1-5 | wt. % | TiO₂, |
| 0.5-3 | wt. % | BaO, |
| 0-2 | wt. % | Sro, |
| 0-3 | wt. % | ZrO₂, and |
| 0-1 | wt. % | CuO, |

wherein a total fraction of Na₂O and K₂O is at most 1.0 wt. %,
wherein a total fraction of SrO, CuO, and ZrO₂ lies in a range of 0.1 to 4.0 wt. %,
wherein the temperature-resistant alumosilicate glass fiber has a transformation temperature >760° C. and a fiber formation temperature at a glass melt viscosity of 10^{3.0} dPa·s of <1260° C., and
wherein a remaining residual strength of the glass fiber with a diameter of from 9 to 15 μm after a temperature stress of 760° C. is in a range of 10% to 15% compared to an initial tear strength at room temperature.

2. The temperature-resistant alumosilicate glass fiber according to claim 1, which comprises Na₂O with a maximum fraction of 0.25 wt. %.

3. The temperature-resistant alumosilicate glass fiber according to claim 1, which comprises SiO₂ with a fraction in a range of 54.0 to 58.0 wt. %.

4. (canceled)

5. The temperature-resistant alumosilicate glass fiber according to claim 1, which comprises MgO with a fraction in a range of 0.5 to 0.8 wt. % and Fe₂O₃ with a fraction of at maximum 0.3 wt. %.

6. The temperature-resistant alumosilicate glass fiber according to claim 1, which is in a form of a filament or a staple fiber.

7. A method for producing the temperature-resistant alumosilicate glass fiber according to claim 1, the method comprising:
a. preparing a glass melt comprising:

| | | |
|---|---|---|
| 52 to 60 | wt. % | SiO₂, |
| 14 to 16 | wt. % | Al₂O₃, |
| <0.4 | wt. % | Fe₂O₃, |
| 0.03 to 0.3 | wt. % | Na₂O, |
| 0.3 to 0.7 | wt. % | K₂O, |
| 20 to 22 | wt. % | CaO, |
| 0.4 to 0.8 | wt. % | MgO, |
| 1 to 5 | wt. % | TiO₂, |
| 0.5 to 3 | wt. % | BaO, |
| 0 to 2 | wt. % | SrO, |
| 0 to 3 | wt. % | ZrO₂, and |
| 0 to 1 | wt. % | CuO, |

wherein a total fraction of Na₂O and K₂O is at most 1.0 wt. %, and
wherein a total fraction of SrO, CuO, ZrO₂ lies in a range of 0.1 to 4.0 wt. %,
b. converting the melt into filaments or staple fibers,
c. cooling the filaments or staple fibers,
d. coiling the filaments into spin threads or making textiles, and
e. of drying the resulting filaments or staple fibers or textiles.

8. The method according to claim 7, wherein in said preparing a, a fraction of a total fraction of BaO is added as barium sulfate with a fraction of 0.4 wt. %.

9. The method according to claim 7, wherein the filaments and staple fibers obtained from the glass melt are treated with a size.

10. The method according to claim 7, wherein the size comprises an inorganic substance.

11. An article, comprising:
the temperature-resistant alumosilicate glass fiber according to claim 1,
wherein the article is a high-tensile glass fiber, twine, fleece, fabric, a textile, fabric for a catalyst, a filter, or other fiber products.

12. The article according to claim 11, wherein the article is a textile, which consists of temperature-resistant alumosilicate glass fibers that are thermally desized and treated with a finish.
